(19) United States
(12) Patent Application Publication
(10) Pub. No.: US 2019/0152456 A1
(43) Pub. Date: May 23, 2019

(54) BRAKE SYSTEM AND METHOD FOR THE OPERATION THEREOF

(71) Applicant: Continental Teves AG & Co. oHG, Frankfurt (DE)

(72) Inventors: Lothar Schiel, Hofheim (DE); Manfred Rüffer, Sulzbach (DE)

(21) Appl. No.: 16/316,678

(22) PCT Filed: Jul. 12, 2017
(86) PCT No.: PCT/EP2017/067526

§ 371 Date: Jan. 10, 2019

(30) Foreign Application Priority Data
Jul. 25, 2016 (DE) 10 2016 213 604.6
Jun. 14, 2017 (DE) 10 2017 210 078.8

(51) Int. Cl. B60T 8/40; B60T 8/38

(52) U.S. Cl. CPC B60T 8/4086; B60T 2270/60; B60T 8/38

(57) ABSTRACT

A brake system for motor vehicles has a master brake cylinder having at least a first and a second master brake cylinder piston, arranged one behind the other and bound a first and second pressure space. Wheel brakes are connected to each a brake circuit. The first master brake cylinder piston is connected to a brake pedal via a pressure rod. An atmospheric pressure medium storage tank is assigned to the pressure spaces at, per brake circuit, an electrically controllable pressure source with a suction connection and a pressure connection. The pressure connection connected to the wheel brakes. The suction connection connected to the master brake cylinder via a normally closed valve, and, per brake circuit, a normally open valve via which the master brake cylinder is connected to the wheel brakes. Per brake circuit, the suction connection is connected to the pressure medium storage tank via a first valve.

### CROSS REFERENCE TO RELATED APPLICATIONS

This application is the U.S. National Phase Application of PCT International Application No. PCT/EP2017/067526, filed Jul. 12, 2017, which claims priority to German Patent Application No. 10 2017 210 078.8, filed Jun. 14, 2017, and German Patent Application No. 10 2016 213 604.6, filed Jul. 25, 2016, the contents of such applications being incorporated by reference herein.

### FIELD OF THE INVENTION

The invention relates to a brake system according to the preamble of claim 1 and to method for operating such a brake system.

### BACKGROUND OF THE INVENTION

US 2015/0061366 A1, incorporated by reference, discloses a brake system without a vacuum brake booster, with a tandem master brake cylinder, to each of the two pressure spaces of which a brake circuit with wheel brakes is connected, wherein the first master brake cylinder piston is connected directly to a brake pedal, and a pressure medium storage tank. Per brake circuit, there are an electrically controllable pump, the pressure connection of which is connected to the wheel brakes of the brake circuit via one inlet valve per wheel brake and the suction connection of which can be connected to the corresponding pressure space via a normally closed suction valve, and a normally closed isolating valve via which the corresponding pressure space of the master brake cylinder can be connected to the wheel brakes of the brake circuit. The brake system comprises an additional electrically controllable pressure source in the form of a motor-operated, dual-circuit cylinder device, the two pressure chambers of which being connected to one of the brake circuits in each case. Owing to the additional electrically controllable pressure source, the known brake system is relatively costly and large.

### SUMMARY OF THE INVENTION

An aspect of the present invention is a brake system which does not require any under pressure and is nevertheless cost-effective, compact and light in weight. In this context, the brake system is also to be suitable for recuperative braking, various assistance functions and autonomous driving. A further aspect of the invention is a method for operating the brake system.

An aspect of the invention is based on the concept that, per brake circuit, the suction connection of the pressure source is additionally connected to the pressure medium storage tank via a (first) valve. The pressure source can therefore, additionally or alternatively to sucking pressure medium out of the master brake cylinder, suck pressure medium volume out of the pressure medium storage tank when necessary.

The brake system according to an aspect of the invention therefore constitutes a combined auxiliary-force and external-force brake system. During braking, it is possible to switch over between an auxiliary-force operating mode and an external-force operating mode.

The first master brake cylinder piston is connected (directly) to a brake pedal via a pressure rod which transmits activation forces, i.e. there is no brake booster, e.g. vacuum brake booster, connected between the brake pedal and master brake cylinder.

The first valve is preferably of normally closed design, in order to use proven and cost-effective series-production (valve) technology and to be able to better control the volume flows in the brake system during activation. It is ensured that the volume component which is introduced into the wheel brakes by the driver via the master brake cylinder, and the volume component which the pressure source sucks in directly from the pressure medium storage tank can be more precisely determined and/or estimated (e.g. from a model calculation).

According to an aspect of the invention, a brake pedal activation variable is understood to be a physical variable which is characteristic of the degree of movement of the brake pedal when activation by the driver occurs. A pressure which is generated in the master brake cylinder is not a brake pedal activation variable in this sense (according to the terminology of this application). A brake pedal activation variable is e.g. a brake pedal angle, a brake pedal travel or a position or a displacement travel of the first master brake cylinder piston.

In the brake system according to an aspect of the invention, both a brake pedal activation variable and a pressure which is generated in the master brake cylinder by the applied force of a foot are preferably acquired or measured. The specified variables together characterize the deceleration request of the driver.

The third valves, by means of which the master brake cylinder is connected to the wheel brakes, are preferably of normally open design, in order e.g. to permit the driver to engage hydraulically with the wheel brakes in the event of a power failure of the brake system.

One low-pressure accumulator is preferably provided per brake circuit, wherein the suction connection of the pressure source is connected to the low-pressure accumulator. The low-pressure accumulator serves e.g. to hold pressure medium from the wheel brakes, e.g. in the event of a reduction in brake pressure via one of the outlet valves.

An outlet valve, via which the wheel brake is connected to the corresponding low-pressure accumulator, is preferably provided for each wheel brake.

Furthermore, an inlet valve, which is arranged between the corresponding third valve and the wheel brake, is preferably provided for each wheel brake.

According to one development of an aspect of the invention, a brake pedal sensation simulator is integrated into the second master brake cylinder piston, said brake pedal sensation simulator comprising a simulator piston which is guided in the second master brake cylinder piston and is supported on the second master brake cylinder piston via an elastic element. The brake pedal sensation simulator permits a brake pedal stroke in operating situations in which the brake pedal is activated and the suction sides of the pressure sources are not connected to the master brake cylinder but rather to the pressure medium storage tank.

The brake pedal sensation simulator is preferably configured in such a way that when the brake pedal is activated the simulator piston cannot be moved until the second pressure space is shut off hydraulically. The brake pedal sensation simulator therefore permits a brake pedal stroke even if the master brake cylinder pressure spaces are disconnected hydraulically from the wheel brakes and the suction sides, e.g. by means of the first and third valves.

The brake system preferably does not have a further electrically controllable pressure source.

A pressure measuring device for recording a pressure of the master brake cylinder and a position measuring device for recording a brake pedal activation variable are preferably provided in the brake system.

The pressure measuring device particularly preferably records the pressure in the second pressure space of the master brake cylinder.

The position measuring device particularly preferably records a displacement of the first master brake cylinder piston.

An aspect of the invention also relates to a method for operating a brake system.

In order to build up brake pressure at the wheel brakes, in a second brake activation phase, it is preferred that the first valves are opened, and the pressure sources are actuated. It is particularly preferred here that the second valves are in a closed state or are closed. In the second brake activation phase, pressure medium is therefore fed into the wheel brakes from the pressure medium storage tank via the first valves by means of the pressure sources.

The second brake activation phase is preferably carried out when, owing to activation of the brake pedal by the driver, a predetermined second pressure value is reached in the master brake cylinder. The second brake activation phase is particularly preferably carried out when the second pressure value is reached in the second pressure space of the master brake cylinder.

The second brake activation phase is preferably additionally or alternatively carried out when, owing to activation of the brake pedal by the driver, a brake pedal activation variable reaches a predetermined second value. The second brake activation phase is particular preferably carried out when the displacement of the first master brake cylinder piston reaches a predetermined second limiting value.

A predetermined second pressure value, value or limiting value is understood to be a pressure value, value or limiting value which is predefined or defined (e.g. is stored in an electronic open-loop and closed-loop control unit of the brake system) or which is acquired in a situation-dependent fashion (e.g. in an electronic open-loop and closed-loop control unit, e.g. on the basis of sensor data, vehicle movement dynamics conditions etc.).

A second target output pressure of the pressure source is preferably determined on the basis of a measured pressure of the master brake cylinder and of a second predefined functional relationship, and during the second brake activation phase the output pressure of the pressure source is set to the determined second target output pressure. If the brake system does not have a brake pedal sensation simulator, a brake activation variable is preferably not taken into account during the determination of the second target output pressure. If the brake system has an integrated brake pedal sensation simulator, the second target output pressure of the pressure source is therefore preferably determined on the basis of a measured pressure of the master brake cylinder, a brake activation variable and a second predefined functional relationship.

The second brake activation phase is alternatively or additionally carried out when a braking operation is requested by an autopilot function. The second brake activation phase is also carried out when the driver has not activated the brake pedal.

In order to build up brake pressure at the wheel brakes, when the brake pedal is activated by a driver, in a brake first activation phase the suction connections of the pressure sources are preferably in a state of connection or are connected to the master brake cylinder by means of the second valves, and the pressure sources are actuated. Pressure medium is therefore fed into the wheel brakes from the master brake cylinder via the second valves by means of the pressure sources.

During the first brake activation phase, the third valves are preferably closed so that pressure medium is not fed in the circuit.

A first target output pressure of the pressure source is preferably determined on the basis of a measured pressure of the master brake cylinder, of a measured brake pedal activation variable and of a first predefined functional relationship, and during the first brake activation phase the pressure sources are actuated in such a way that the output pressure of the pressure sources is set to the determined first target output pressure.

The first brake activation phase is preferably carried out when, owing to activation of the brake pedal by the driver, a first predefined pressure value is reached in the master brake cylinder. The first brake activation phase is particularly preferably carried out when a first predefined pressure value is reached in the second pressure space of the master brake cylinder.

The first brake activation phase is preferably additionally or alternatively carried out when, owing to activation of the brake pedal by the driver, a brake pedal activation variable reaches a first predefined value. The first brake activation phase is particular preferably carried out when the displacement of the first master brake cylinder piston reaches a first predefined limiting value.

In this context, the first pressure value for initiating the first brake activation phase is preferably lower than the second pressure value for initiating the second brake activation phase, and the first predefined value/limiting value is lower than the second predefined value/limiting value.

At the start of the activation of the brake pedal, in a preliminary phase the second and the third valves are preferably opened or in an open state and the pressure sources are not actuated. Pressure medium is therefore displaced from the master brake cylinder into the wheel brakes and to the suction sides of the pressure sources by the driver.

The measured pressure of the master brake cylinder is particularly preferably the measured pressure of the second pressure space of the master brake cylinder.

The measured brake pedal activation variable is particularly preferably a measured displacement of the first master brake cylinder piston.

The brake system according to an aspect of the invention and the method according to an aspect of the invention for operating the brake system also provide the advantage of a known brake pedal sensation for the driver.

### BRIEF DESCRIPTION OF THE DRAWINGS

Further preferred embodiments of the invention will emerge from the claims and the following description with reference to figures.

In the figures, in each case schematically:

FIG. 1 shows a first exemplary brake system, and

FIG. 2 shows the integrated brake pedal sensation simulator of the brake systems from FIG. 1 in a view of a detail.

### DETAILED DESCRIPTION OF THE PREFERRED EMBODIMENTS

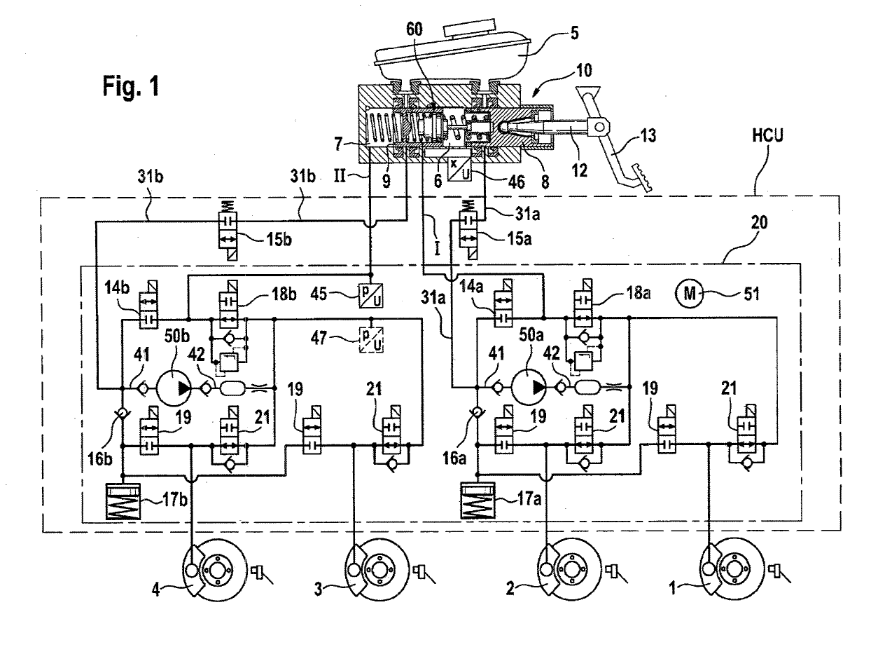

FIG. 1 schematically illustrates a first exemplary brake system of a motor vehicle.

The brake system comprises a master brake cylinder 10 which can be activated by a brake pedal and has two pressure spaces 6, 7, wherein each pressure space 6 or 7 is assigned a brake circuit I or II with two wheel brakes 1, 2 and 3, 4, respectively, and a pressure medium storage tank 5 which is assigned to the master brake cylinder and is at atmospheric pressure.

The dual-circuit master brake cylinder 10 comprises two pistons 8, 9 which are arranged in series and which bound two hydraulic pressure spaces 6, 7 in a housing. The brake pedal 13 is mechanically coupled directly to a pressure rod (piston rod) 12 which is mechanically coupled directly or connected directly to the first piston 8, i.e. the first piston 8 is directly connected to the brake pedal 13 by means of the pressure rod 12 which transmits activation forces, and said first piston 8 is activated directly by the vehicle driver, without the interconnection of a brake booster.

The pressure spaces 6, 7 are assigned pressure equalization lines (not denoted in more detail) leading to the pressure medium storage tank 5, and the hydraulic connection is disconnected when the pistons 8, 9 are displaced.

The brake system also comprises, for example, a hydraulic open-loop and closed-loop control unit HCU, which corresponds to a modified ESC design (ESC: Electronic Stability Control).

The hydraulic open-loop and closed-loop control unit HCU is preferably assigned an electronic open-loop and closed-loop control unit ECU (not illustrated).

The hydraulic open-loop and closed-loop control unit comprises a dual-circuit motor-pump assembly with two pumps 50a, 50b, which are driven jointly by an electric motor 51, in particular brushless motor, and, per brake circuit I, II, a low-pressure accumulator 17a or 17b and two electrically controllable valves 18a, 14a and 18b, 14b, respectively. An inlet valve 21 and an outlet valve 19 for setting wheel-specific brake pressures for the wheel brakes are provided for each wheel brake 1-4.

The master brake cylinder pressure space 8 or 9 is connected to the wheel brakes 1, 2 and 3, 4, respectively, of the corresponding brake circuit I or II via the, advantageously normally open, valve 18a or 18b (third valve).

The inlet valve 21 is respectively arranged between the master brake cylinder 10, in particular the valve 18a or 18b, and the wheel brake 1-4. That is to say the input connections of the inlet valves 21 are connected brake-circuit-wise (I, II) to the master brake cylinder 10 by means of a line in which the valve 18a or 18b is arranged. The wheel brake 1-4 can be connected to the corresponding low-pressure accumulator 17a or 17b via the outlet valve 19, in order to discharge pressure medium, e.g. for a reduction of wheel brake pressure. That is to say the output connections of the outlet valves 19 are connected brake-circuit-wise to the hydraulic low-pressure accumulator 17a or 17b.

Each pump 50a, 50b comprises a suction connection 41 and a pressure connection 42, wherein the pressure connection 42 is connected to the wheel brakes 1, 2 and 3, 4, respectively, of the corresponding brake circuit I or II, and wherein the suction connection 41 is connected to the corresponding pressure space 8 or 9 of the master brake cylinder 10 via the, advantageously normally closed, (second) valve 14a, 14b.

Each low-pressure accumulator 17a, 17b is connected to the suction side 41 of the corresponding pressure source, e.g. pump 50a, 50b, via a non-return valve 16a, 16b which closes in the direction of the low-pressure accumulator.

In addition to the ESC module design 20, known per se, one hydraulic connection 31a, 31b per brake circuit I, II is provided from the suction side 41 of the pump 50a, 50b to the pressure medium storage tank 5, in which hydraulic connection 31a, 31b an, advantageously normally closed, connection valve (first valve) 15a, 15b is arranged. The hydraulic connections 31a, 31b are independent of the position of the master brake cylinder piston 8, 9.

The pressure connections 42 of the pressure sources 50a, 50b are connected to the connecting line between the third valve 18a, 18b and associated inlet valves 21 via one hydraulic pulsation damping element (not denoted in more detail) in each case.

In order to record a master brake cylinder pressure, the brake system has, for example, a pressure measuring device 45, e.g. a pressure sensor which is of redundant design, in order to record the pressure in the second pressure space 7 of the master brake cylinder 10.

Furthermore, the brake system comprises a position measuring device 46 for recording a brake pedal activation variable. A displacement of the first master brake cylinder piston 8 is preferably recorded as a brake pedal activation variable.

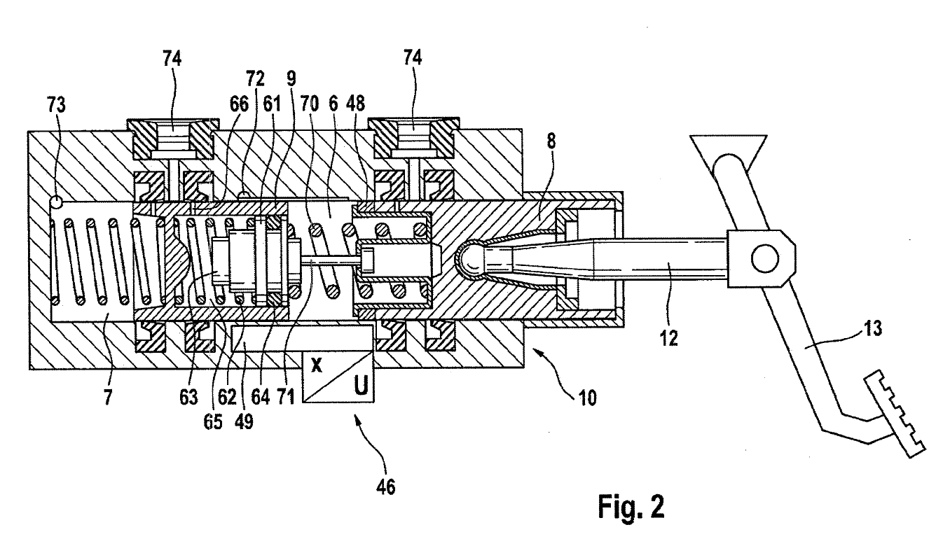

The exemplary brake system comprises a brake pedal sensation simulator 60. For this purpose, the second master brake cylinder piston 9 is provided with an integrated simulator piston 61. Details of the brake pedal sensation simulator 60 are explained in more detail in relation to FIG. 2.

FIG. 2 shows the brake pedal sensation simulator 60, integrated into the master brake cylinder 10, of the brake systems from FIG. 1 in a view of a detail. The brake pedal sensation simulator 60 is integrated into the second master brake cylinder piston 9. The brake pedal sensation simulator 60 comprises a piston 61 which is guided in the second master brake cylinder piston 9 and is supported on the second master brake cylinder piston 9 via an elastic element 62, e.g. a simulator spring.

A first connection 72 for connecting the first pressure space 6 to the brake circuit I is provided on the master brake cylinder 10, and correspondingly a second connection 73 is provided for connecting the second pressure space 7 to the brake circuit II. The master brake cylinder 10 can be connected to the pressure medium storage tank 5 via the pressure medium storage tank connections 74.

An elastomer stop 63 is attached to the simulator piston 61 in the region facing away from the brake pedal, which elastomer stop 63 comes to bear on the master brake cylinder piston 9 when the simulator piston 61 is displaced sufficiently.

A simulator seal 64 is arranged between the master brake cylinder piston 9 and the simulator piston 61, which simulator seal 64 seals off the first pressure space 6 of the master brake cylinder 10 from a simulator space 65 which is bounded by the master brake cylinder piston 9 and the simulator piston 61. A passage 66, via which the simulator space 65 is connected to the pressure medium storage tank connection 74, is provided in the master brake cylinder piston 9.

The master brake cylinder piston 8 is supported on the simulator piston 61 via a first spring 70 which is advantageously prestressed and arranged in the first pressure space 6. An anchoring sleeve and an anchoring screw 71 are arranged between the master brake cylinder piston 8 and the simulator piston 61.

A second spring (not denoted in more detail) for returning the second piston 9 is arranged in the second pressure space 7 of the master brake cylinder 10, which second spring is supported on the housing of the master brake cylinder 10.

For example, the position measuring device 46 comprises a magnetic ring 48 which is arranged on the piston 8 and whose displacement is recorded by a displacement sensor element 49 which is arranged in the master brake cylinder housing.

When the brake pedal 13 is activated, the piston 8 is displaced, and the piston 9, including the simulator piston 61 is displaced via the first spring 70, as long as pressure medium can escape from the pressure spaces 6, 7. If the pressure space 7 is closed off by closing the valves 14a, 14b (when the valves 18a, 18b are closed), the piston 9 can no longer be displaced. However, a further displacement of the piston 8 (and therefore a further pedal stroke) continues to be possible owing to a displacement of the simulator piston 61 in the fixed piston 9.

The integrated brake pedal sensation simulator 60 is therefore configured in such a way that it cannot be moved until the valves 14a, 14b close.

For example, the brake system in FIG. 1 is operated as follows in the case of normal braking (with boosting) initiated by the driver:

The driver activates the brake pedal 13 and displaces the piston rod 12 which is coupled directly to the first piston 8 of the master brake cylinder 10. This movement is recorded by means of the position measuring device 46.

In a so-called preliminary phase (filling phase) at the start of the brake activation, the driver is connected directly to the wheel brakes 1-4 via the open or opened third valves 18a, 18b (and also open or opened inlet valves 21), and can apply the brake linings and/or pre-fill the wheel brakes 1-4.

At the same time, the second valves 14a, 14b are in an opened state or are opened. The electrically controllable pressure source 50a, 50b is therefore also pre-filled by the master brake cylinder 10.

After this preliminary phase, defined e.g. by trials, the third valves 18a, 18b are closed. In the following first brake activation phase, the direct hydraulic connection between the master brake cylinder 10 (driver) and wheel brakes 1-4 is interrupted (third valves 18a, 18b are closed), but the second valves 14a, 14b remain opened, with the result that the driver continues to act on the suction side 41 of the pressure source 50a, 50b. The pressure sources 50a, 50b are actuated in order to feed a higher brake pressure to the wheel brakes 1-4.

The target brake pressure which is to be generated by the pressure sources 50a, 50b is acquired from a defined (first) relationship of the brake pedal activation variable (e.g. pedal travel or travel of the piston 8, by means of a position measuring device 46) and the pressure at the pressure measuring device 45.

As a result of the gentle run-up of the pressure sources 50a, 50b, the driver only has to “track” with his foot in order to make available the volume which is necessary for the buildup of pressure. Therefore, a “jumping behavior” which is known from a vacuum booster can be implemented.

For example, the preliminary phase ends or the first brake activation phase starts if, owing to the actuation of the brake pedal, a first predefined pressure value is reached in the second pressure space 7 of the master brake cylinder 10 (e.g. 1 bar) or the brake pedal activation variable reaches a first predefined value, e.g. the displacement of the first master brake cylinder piston 8 reaches a first predefined limiting value.

In the case of a second limiting value for the brake pedal activation variable (e.g. the pedal travel or the displacement of the piston 8) which has been previously defined or acquired in a situation-dependent fashion or in the case of a second pressure value for the master cylinder pressure (pressure measuring device 45), which has been previously defined or acquired in a situation-dependent fashion, the second valves 14a, 14b are also closed. At the same time as the closing of the valves 14a, 14b, the tank connections 31a, 31b leading to the pressure sources 50a, 50b are opened (by opening the first valves 15a, 15b) in order to make available a pressure medium volume for the further buildup of pressure. This corresponds to a second brake activation phase or initiates a second brake activation phase.

In the second brake activation phase, the pressure sources 50a, 50b are actuated in such way that a second target output pressure is set. The second target output pressure is determined on the basis of the measured master brake cylinder pressure, for example of the pressure of the second master brake cylinder pressure space, and of a second predefined functional relationship. For example, the second target output pressure is mainly acquired by means of the pressure sensor 45, and then the output pressure of the pumps 50a, 50b is set, e.g. no brake activation variable is taken into account, if the brake system does not comprise a brake pedal sensation simulator.

If the piston 9 is provided with an integrated brake pedal sensation simulator 60 which, according to its configuration, cannot be moved until the closing of the valves 14a, 14b is brought about, this permits a further pedal stroke for the driver. Therefore, in this second brake activation phase there are also two physically redundant signals available (master brake cylinder pressure and brake pedal activation variable) for the recording of the driver's request. Then, the second target output pressure is determined on the basis of the measured master brake cylinder pressure, for example of the pressure of the second master brake cylinder pressure space, and of the measured brake activation variable.

Preferably an electric motor 51 which can be well regulated is provided for driving the pumps 50a, 50b.

When the brake is released by the driver, an advantageous switching sequence of the valves into the initial position is selected.

A vehicle movement dynamics control operation can be carried out with the brake system according to an aspect of the invention in the previously customary fashion.

The brake system according to an aspect of the invention permits a remote control facility and/or assistance functions. In this context, the supply of volume to the pressure source 50a, 50 likewise takes place via the first valves 15a, 15b (second brake activation phase) and the brake pressure which has been set does not have to correspond to the driver's specifications.

By adding a pressure measuring device 47 in at least one of the brake circuits I or II (for example downstream of the valve 18b in the brake circuit II in FIG. 1), the brake system is also made suitable for autonomous driving. A buildup of braking pressure at the wheel brakes 1-4 also takes place without activation of the brake pedal by the driver by means of the pressure sources 50a, 50 in the case of a pressure medium supply via the opened first valves 15a, 15b (when the second valves 14a, 14b are closed; corresponding to the second brake activation phase).

The brake system according to an aspect of the invention for motor vehicles does not require any under pressure. It is therefore not necessary for a vacuum source/under pressure source, such as e.g. a vacuum pump, to be present in the motor vehicle. The brake system does not require a vacuum booster.

A simple, cost-effective, robust and reliable brake system for hydraulic wheel brakes is proposed which does not require a vacuum and is suitable for recuperative braking and extensive assistance functions.

The electrically controllable pressure source can be embodied as an electrically operated hydraulic pump of a known design, e.g. as a piston pump, or as an electrohydraulic linear actuator.

The brake system for the functions of normal braking and standard vehicle movement dynamics control is implemented with very simple means at minimum cost.

Since the brake system only has one energy source (apart from the driver's foot), the hydraulically effective area of the master brake cylinder is preferably selected to be so small that, in the event of a fault, a vehicle deceleration is possible which is significantly above the legally required braking (2.44 m/s²) with the maximum legally permitted foot force.

The brake system according to an aspect of the invention can optionally be constructed in a modular fashion, in the sense of a first unit/module with a master brake cylinder 10 and a separate, second unit/module composed of the hydraulic and electronic open-loop and closed-loop control unit HECU (Hydraulic/Electronic Control Unit, with a hydraulic open-loop and closed-loop control unit HCU and an electronic open-loop and closed-loop control unit ECU), or as a single module with a master brake cylinder 10 and HECU (Onebox).

Of course, the maximum pedal travel is limited by the vehicle. The volume of the master brake cylinder is preferably configured on the basis of the volume demand which can be achieved thereby.

### EXAMPLE

Volume demand for full braking (1 g): 9 cm³

Deceleration which can be achieved with 500 N foot force: 0.5 g

Volume necessary for this: 4.6 cm³

The configuration of the master brake cylinder which is aimed at is for preferably approximately twice the emergency braking volume with pedal travel present and with the smallest possible master brake cylinder diameter.

### EXAMPLE

Master brake cylinder diameter: 19.05 mm

Overall stroke: 38.00 mm

Volume output approximately: 10.80 cm³

In the case of emergency braking and when there is a further demand for pressure medium volume for relatively high brake pressures, the pressure sources obtain the additionally required volume via the valves 15a, 15b proposed according to an aspect of the invention (via the connections 31a, 31b).

Advantages of aspects of the invention:
The brake system provides a familiar brake pedal sensation and permits a vacuum booster response characteristic which can be easily set by means of software, in a requirement-specific fashion.
The system is vacuumless. This brings about a reduction in CO₂ of more than 1 g/km.
The brake system requires relatively few components.
The brake system is compact (advantageous packaging).
The brake system provides weight advantages.
The brake system is based on a proven and known basic system (ESC module 20) and in this respect is based on proven technology.
The brake system comprises a “power on demand” pressure source (50a/50b).

### LIST OF REFERENCE SIGNS

1 Wheel brake

2 Wheel brake

3 Wheel brake

4 Wheel brake

5 Pressure medium storage tank

6 First pressure space

7 Second pressure space

8 First master brake cylinder piston

9 Second master brake cylinder piston

10 Master brake cylinder

12 Pressure rod

13 Brake pedal

14a, 14b Second valve

15a, 15b First valve

16a, 16b Non-return valve

17a, 17b Low-pressure accumulator

18a, 18b Third valve

19 Outlet valve

20 ESC

21 Inlet valve

31a, 31b Hydraulic connection

41 Suction connection

42 Pressure connection

45 Pressure measuring device

46 Position measuring device

47 Pressure measuring device

48 Magnetic ring

49 Displacement sensor element

50a, 50b Pump

51 Electric motor

60 Brake pedal sensation simulator

61 Simulator piston

62 Elastic element

63 Elastomer stop

64 Simulator seal

65 Simulator space

66 Passage

70 First spring

71 Anchoring screw

72 First connection

73 Second connection

74 Pressure medium storage container connection

1. A brake system for motor vehicles comprising:
a master brake cylinder which has at least a first and a second master brake cylinder piston, which are arranged one behind the other and bound a first and a second pressure space, to each of which a brake circuit with wheel brakes is connected, wherein the first master brake cylinder piston is connected to a brake pedal via a pressure rod which transmits activation forces,
a pressure medium storage tank which is assigned to the pressure spaces and is at atmospheric pressure,
per brake circuit, an electrically controllable pressure source with a suction connection and a pressure connection, wherein the pressure connection is connected to the wheel brakes of the brake circuit, and wherein the suction connection is connected to the master brake cylinder via a second, normally closed, valve, and
per brake circuit, a third normally open valve via which the master brake cylinder is connected to the wheel brakes of the brake circuit,
wherein,
per brake circuit the suction connection of the pressure source is connected to the pressure medium storage tank via a first normally closed valve.

2. The brake system as claimed in claim 1, wherein per brake circuit a low pressure accumulator, for holding pressure medium from the wheel brakes, is provided, wherein the suction connection of the pressure source is connected to the low pressure accumulator.

3. The brake system as claimed in claim 1, wherein a brake pedal sensation simulator is integrated into the second master brake cylinder piston, said brake pedal sensation simulator comprising a simulator piston which is guided in the second master brake cylinder piston and is supported on the second master brake cylinder piston via an elastic element.

4. The brake system as claimed in claim 3, wherein the brake pedal sensation simulator is configured in such way that when the brake pedal is activated the simulator piston cannot be moved until the second pressure space is shut off hydraulically, the first and third valves.

5. The brake system as claimed in claim 1, wherein the brake system is absent a further electrically controllable pressure source.

6. A method for operating a brake system as claimed in claim 1, wherein in order to build up brake pressure at the wheel brakes, in a second brake activation phase, the first valves are in an opened state or are opened, the second valves are in a closed state or are closed, and the pressure sources are actuated.

7. The method as claimed in claim 6, wherein the second brake activation phase is carried out when, owing to activation of the brake pedal by the driver,
a predetermined, second pressure value in the master brake cylinder, in the second pressure space of the master brake cylinder, is reached or
a brake pedal activation variable reaches a predetermined, second value, the displacement of the first master brake cylinder piston reaches a predetermined second limiting value.

8. The method as claimed in claim 6, wherein a second target output pressure of the pressure source is determined on the basis of a measured pressure of the master brake cylinder, of the second pressure space of the master brake cylinder, and of a second predefined functional relationship, and in that during the second brake activation phase the output pressure of the pressure source is set to the determined second target output pressure.

9. The method as claimed in claim 6, wherein the second brake activation phase is carried out when a braking operation is requested by an autopilot function, and when the driver has not activated the brake pedal.

10. The method as claimed in claim 6, wherein in order to build up brake pressure at the wheel brakes when the brake pedal is activated by a driver, in a first brake activation phase, the suction connections of the pressure sources are in a state of connection, or are connected, to the master brake cylinder by the second valves, and the pressure sources are actuated.

11. The method as claimed in claim 10, wherein the third valves are closed during the first brake activation phase.

12. The method as claimed in claim 10, wherein a first target output pressure of the pressure source is determined on the basis of a measured pressure of the master brake cylinder, of the second pressure space of the master brake cylinder, of a measured brake pedal activation variable, of a measured displacement of the first master brake cylinder piston, and of a first predefined functional relationship, and in that during the first brake activation phase the pressure sources are actuated in such a way that the output pressure of the pressure sources is set to the determined first target output pressure.

13. The method as claimed in claim 10, wherein the first brake activation phase is carried out when, owing to activation of the brake pedal by the driver,
a first predefined pressure value in the master brake cylinder, in the second pressure space of the master brake cylinder, is reached or
a brake pedal activation variable reaches a first predefined value, the displacement of the first master brake cylinder piston reaches a first predefined limiting value.

14. The method as claimed in claim 6, wherein at the start of the actuation of the brake pedal, in a preliminary phase, the second and the third valves are in an open state or are opened and the pressure sources are not actuated.

15. The brake system as claimed in claim 2, wherein a brake pedal sensation simulator is integrated into the second master brake cylinder piston, said brake pedal sensation simulator comprising a simulator piston which is guided in the second master brake cylinder piston and is supported on the second master brake cylinder piston via an elastic element.

16. The method as claimed in claim 7, wherein a second target output pressure of the pressure source is determined on the basis of a measured pressure of the master brake cylinder, of the second pressure space of the master brake cylinder, and of a second predefined functional relationship, and in that during the second brake activation phase the output pressure of the pressure source is set to the determined second target output pressure.
